(19) United States
(12) Patent Application Publication
(10) Pub. No.: US 2026/0322628 A1
(43) Pub. Date: Oct. 15, 2026

(54) Automated and On-Demand Dynamic Rotation of Kubernetes and ETCD Certificates Using a Service Mesh as a Distributed Storage Mechanism

(71) Applicant: Rafay Systems, Inc., Sunnyvale, CA (US)

(72) Inventors: Venkata Murali Sai Vihari Panathula, Bengaluru (IN); Sudhir Babu Chinnamadela, Bangalore (IN); Chaithanya Vuppara, Bangalore (IN); Vasu Dokala, Bangalore (IN); Rupinder Singh Gill, Carrara (AU); Hanumantha Rao Kavuluru, San Jose, CA (US)

(73) Assignee: Rafay Systems, Inc., Sunnyvale, CA (US)

(21) Appl. No.: 19/646,175

(22) Filed: Apr. 13, 2026

Related U.S. Application Data
(60) Provisional application No. 63/788,473, filed on Apr. 14, 2025.

(51) Int. Cl. H04L 9/32

(52) U.S. Cl. CPC H04L 9/3268

(57) ABSTRACT

System and Method Using a Service Mesh for Rotation of Kubernetes and ETCD

A distributed computing system includes Kubernetes cluster with a plurality of cluster nodes and a mesh network with a plurality of relay nodes. The cluster nodes include configuration files. A Kubernetes certificate authority (k8s-ca) generates Kubernetes certificates (k8s-crts). The mesh network is operable, while the configuration files of the cluster nodes store a copy of a previous k8s-crt generated using the k8s-ca, to forward copies of a replacement k8s-crt generated using the k8s-ca, to other relay nodes of the mesh network. Each relay node includes a storage unit to store a copy of the k8s-crt. The mesh network transfers copies of the replacement k8s-crts stored at the relay nodes to the cluster node configuration files to replace the previous k8s-crt in the configuration files.

### RELATED APPLICATIONS

This application claims the benefit of U.S. Provisional Patent Application No. 63/788,473, filed on Apr. 14, 2025, and entitled “Automated and On-Demand Dynamic Rotation of Kubernetes and ETCD Certificates Using a Service Mesh as a Distributed Storage Mechanism, the contents of which are incorporated herein by reference in their entirety.

### BACKGROUND

Kubernetes (sometimes referred to as “k8s”) refers to a category of distributed processing system that improves the operation of cluster-based networks by implementing a control plane that automatically maintains network reachability among dynamically instantiated workloads, including generating stable virtual service endpoints, updating routing state as workloads are created or terminated, and load-balancing network traffic without requiring application-level reconfiguration. A Kubernetes cluster is a distributed processing system comprising a plurality of interconnected processing nodes that collectively execute, manage, and coordinate containerized workloads under the control of a Kubernetes orchestration platform.

In Kubernetes, a Certificate Authority (CA) acts as a trusted cryptographic authority that is responsible for issuing, signing, and managing digital certificates used to authenticate identities and establish secure communications between various processing components within the Kubernetes cluster. The CA performs functions that include issuing certificates, certificate lifecycle management, and authentication.

Kubernetes clusters rely on certificates to secure inter-node communication and interaction with control plane processing components and clients. Certificates can be used for authentication, to ensure that only authorized processing components can communicate with each other, establishing mutual trust. Certificates can be used for identity management, to verify the identity of each processing component, ensuring that they are who they claim to be. Certificates can be used to encrypt data in transit, protecting sensitive information from unauthorized access.

Certificates require periodic rotation to prevent expiration and maintain security. Traditional methods for rotating certificates are typically sequential, resulting in delays and potential disruptions, particularly in large-scale deployments. Certificate rotation typically involves distributing new CA certificates and private keys to all control plane cluster nodes and updating configuration files to use the new certificates. The rotation process generally includes restarting API servers, kubelets, and other processing components to trust the new CA certificates.

Existing rotation solutions fall short in handling large-scale clusters effectively, as they often rely on basic automation or manual processes that do not easily scale.

### BRIEF DESCRIPTION OF THE DRAWINGS

Aspects of the present disclosure are best understood from the following detailed description when read with the accompanying figures. It is emphasized that various features are not drawn to scale in accordance with the standard practice. In fact, the dimensions of the different features may be arbitrarily increased or reduced for clarity of discussion. In addition, the present disclosure may repeat reference numerals and/or letters in the various examples. This repetition is for simplicity and clarity and does not in itself dictate a relationship between the various examples and/or configurations discussed.

FIG. 1 is an illustrative drawing showing an example Kubernetes cluster.

FIG. 2 is an illustrative drawing representing a processing machine that can be configured to operate as a control node or as a worker node of the cluster of FIG. 1.

FIG. 3 is an illustrative drawing of an example distributed computing system that includes the Kubernetes cluster of FIG. 1 integrated with a certificate rotation service mesh network in accordance with some examples.

FIG. 4A is an illustrative diagram representing an example certificate rotation process.

FIG. 4B is an illustrative functional block diagram of an example relay node operative during the example process of FIG. 4A.

FIG. 5 is an illustrative diagram of an example relay node status-tracking process that can run during the certificate rotation process of FIG. 4A.

FIG. 6 is an illustrative diagram of an example relay node control process to control distribution of k8s-certs and etcd-crts during the certificate rotation process of FIG. 4A.

FIGS. 7A-7K are illustrative diagrams that represent additional details of an example dual PKI certificate rotation process involving rotation of k8s-crt, k8s-leaf-crt, etcd-crt, and etcd-leaf-crt in accordance with the example certificate rotation process of FIG. 4A.

### SUMMARY

In one aspect, a distributed computing system is provided. A Kubernetes cluster comprises a plurality of cluster nodes, each of which includes a configuration file. At least one cluster node includes a Kubernetes component operable as a Kubernetes certificate authority (k8s-ca). A mesh network comprises a plurality of relay nodes, each of which includes a storage unit configured to store a replacement copy of a replacement Kubernetes certificate (k8s-crt) distributed to the relay node. The mesh network is operable, while the configuration files at the cluster nodes store a copy of a previous k8s-crt generated using the k8s-ca, to distribute copies of the replacement k8s-crt to the relay nodes of the mesh network. Each cluster node is operable to receive a copy of the replacement k8s-crt from a storage unit at a relay node communicatively coupled to the cluster node, and to input the received copy of the replacement k8s-crt to a configuration file at the cluster node, to replace a copy of the previous k8s-crt stored at the first configuration file.

In another aspect, a method of rotating a Kubernetes certificate is provided. A k8s-ca is used to generate a k8s-crt. A mesh network comprising a plurality of relay nodes is used to distribute copies of a replacement k8s-crt to relay nodes of the mesh network, while configuration files of the cluster nodes store a copy of a previous k8s-crt. Copies of the replacement k8s-crt are stored in storage units at the relay nodes. Copies of the replacement k8s-crt from the different ones of the relay nodes' storage units to different ones of the cluster nodes' configuration files, to replace the previous k8s-crt in the configuration files.

In another aspect, a non-transitory computer-readable storage medium is provided that includes a set of instructions that, when executed by one or more computer processors, causes the one or more computer processors to perform operations. An operation uses a mesh network comprising a plurality of relay nodes to distribute copies of a replacement k8s-crt relay nodes of the mesh network, while one or more configuration files of the cluster nodes store a copy of a previous k8s-crt. An operation stores copies of the replacement k8s-crt in storage units at the relay nodes. An operation transfers copies of the replacement k8s-crt from different ones of the relay nodes' storage units to different ones of the cluster nodes' configuration files to replace the previous k8s-crt in the configuration files.

### DETAILED DESCRIPTION

### Kubernetes Cluster Example

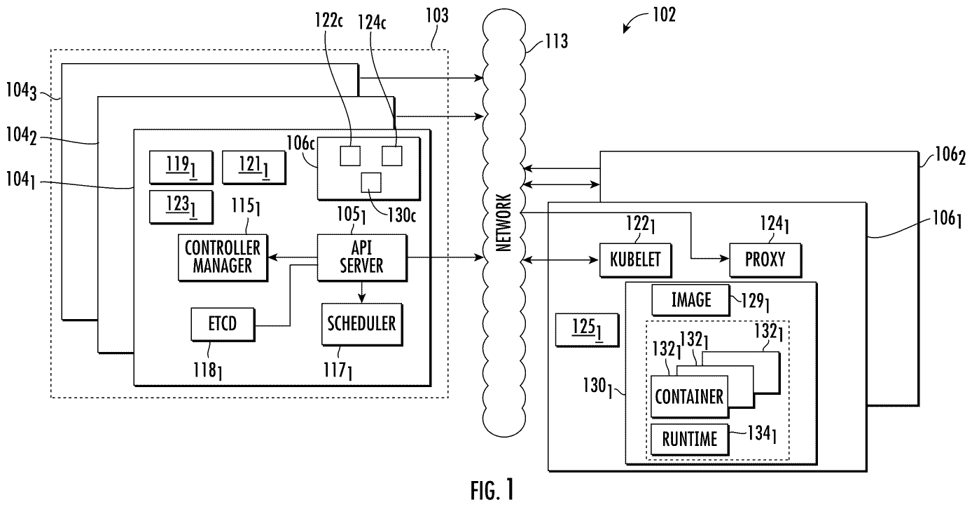

FIG. 1 is an illustrative drawing showing an example Kubernetes cluster 102. The cluster 102 includes multiple cluster nodes. A control plane 103 comprises first, second, and third control plane cluster nodes 104₁, 104₂, 104₃. The cluster 102 also includes first and second worker cluster nodes 106₁, 106₂. The control plane 103 includes multiple control plane cluster nodes 104₁, 104₂, and 104₃ to enable load balancing and redundancy. For the sake of economy of disclosure, reference will be made primarily to information processing components of the first control plane cluster node 104₁ and to information processing components of the first worker node 106₁. The similar operation of the second and third control plane cluster nodes 104₂, 104₃, and of the second worker cluster node 106₂ will be readily understood from the disclosure. Only three control plane cluster nodes, 104₁, 104₂, and 104₃, and two worker nodes, 106₁ and 106₂ are shown. However, as the disclosure below shows, a Kubernetes cluster can include a much larger number of nodes. A typical Kubernetes cluster includes hundreds of cluster nodes, for example.

Control plane cluster nodes 104₁, 104₂, and 104₃, and worker nodes 106₁ and 106₂, are hosted on physical or virtual machines that provide processing resources. A physical or virtual machine that comprises control plane cluster node 104₁ is configured with machine-readable instructions to implement Kubernetes components that include an API (application programming interface) server 105₁, a scheduler 117₁, a kube controller manager server 115₁, an etcd store 118₁, a Kubernetes CA 119₁, and an etcd CA 121₁. The control plane components can run in pods, which are Kubernetes components that are explained more fully below. The API server 105₁ can operate as an interface between the control plane cluster node 104₁ and the worker cluster node 106₁. Moreover, the API server 105₁ can operate as an interface for storing data to and retrieving data from the etcd 118₁. The etcd store 118₁ can operate as a primary data store for the cluster 102, storing configuration information used to determine the entire state of the Kubernetes cluster, including information about nodes, pod specifications, services, network configurations, and security settings. The kube controller manager 115₁ can operate to monitor the etcd store 118₁ for state changes and to use the API server 105₁ to cause adjustments to nodes and pods within the cluster 102 to ensure that the current cluster state matches the desired cluster state. Additionally, the scheduler 117₁ can operate to read cluster data from the etcd store 118₁ to decide where to place new pods among nodes of the cluster 102.

A physical or virtual machine comprises a worker cluster node 106₁ configured with machine-readable instructions to implement additional Kubernetes components that include a pod management agent (commonly referred to as a “kubelet”) 122₁, a network proxy server 124₁ (commonly referred to as a “kube-proxy”), and one or more pods 130₁ that run containerized applications. Example pod 130₁ can include a containerized application 131₁ that may comprise multiple containers 132₁, each using a container runtime 134₁ to communicate with a host worker node's operating system (not shown) to execute. A containerized application 131₁ can span multiple containers 132₁, each of which may execute a part of the application 131₁. A container 132₁ is a runtime unit created using a container runtime 134₁ (e.g., “containerd”) from a container image 129₁ that executes software that is isolated from other containers (e.g., different namespaces, cgroups) inside a pod 130₁. A container image 129₁ acts as a blueprint or read-only template, which does not execute by itself, that bundles information that can include application binaries or source code, runtime, libraries, and dependencies, filesystem layout, and entry point. A container 132₁ is a runtime instance of a container image 129₁, which does not run by itself. A container runtime 134₁ comprises computer program code that provides a container-execution framework, enabling execution of a container 132₁ running an instance of the container image 129₁ using the operating system of the worker node 106₁, such that a container 132₁ runs as an operating system process.

The example worker cluster node 106₁ in the cluster 102 runs an instance of kubelet 122₁. The kubelet 122₁ acts as a client of the API server, communicating with it to send and receive information. However, the kubelet's primary role involves agent functions, including ensuring that containers 132₁ in a pod are running and healthy.

The kubelet 122₁ can communicate with a control plane cluster node, e.g., control plane cluster node 104₁, via the API server 105₁, to send and receive information used to manage the containers 132₁ on the worker cluster node 106₁. For example, kubelet 122₁ can receive a set of instructions from the API server 105₁, in the form of a pod specification (e.g., a YAML file or JSON object), that defines the desired state and configuration of pod 130₁. A pod specification can define containers 132₁ that run within a pod, including application program code, runtime, commands, and arguments, for example. A pod specification can also define resources that pod 130₁ can use, including sharing of processor and storage memory resources. The kubelet 122₁ can use the pod specification as a basis to communicate with container runtimes 134₁ to start, stop, and manage containers 132₁ within a pod 130₁ and to ensure that the containers 132₁ are running, healthy, and in the desired state on the worker cluster node 106₁. The kubelet 122₁ at the worker cluster node 106₁ can report the status of containers 132₁ back to the control plane cluster node 104₁ via the API server 105₁. Each control plane cluster node 104₁-104₃ includes a configuration file 123₁-123₃ that contains configuration information used to configure Kubernetes components of control plane cluster nodes 104₁-104₃. Each worker cluster node 106₁ and 106₂ includes a configuration file 125₁-125₂ that contains configuration information used to configure Kubernetes components of worker cluster nodes 106₁ and 106₂.

An API server 105₁ running on a designated lead control plane cluster node 104₁ acts as a communication interface for communicating with the kubelets 122₁ on worker node 106₁. An example API server is scalable and can scale by deploying more instances. As explained more fully below, Kubernetes CA certificates and keys are used as a type of cryptographic credential to establish secure communication between components (e.g., between control plane cluster node and worker node or between two worker nodes), for example. Kubernetes certificates are used to ensure authenticity, confidentiality, and integrity of such communications.

The control plane cluster nodes 104₁-104₃ also have kubelets, e.g., 121_{C} and proxy servers, e.g., 124_{C}, used to manage local pods, e.g., 130_{C}. The kube-proxy 124₁ includes a virtual filesystem (not shown) used to maintain network rules on the worker node 106₁ to manage the routing of network traffic between services. The kube-proxy supports direct communication between container-based services running in the cluster 102. For example, the kube-proxy 124₁ provides routing information to enable a packet from a service on one worker node to be sent directly to an IP address of another service running in a pod on the same worker node or running in a pod on a different worker node. Services may contact a control plane service such as IP discovery and registration to determine locations of other services within cluster 102.

Kubernetes components within cluster 102 can communicate with one another using HTTPS and a TLS handshake, whether the Kubernetes components are located within the same or different cluster nodes. Network communication between Kubernetes components can be cryptographically protected using a TLS handshake protocol. For example, the kubelet 122₁ and kube-proxy 124₁ running on worker node 106₁ use HTTPS and a TLS handshake to communicate with the API server 105₁ of control plane cluster node 104₁. For example, a container 132₁ running within pod 130₁ can use HTTPS and a TLS handshake to communicate with a different container 132₂ running within the pod 130₁.

As used herein, a cluster “service” refers to a networking abstraction that provides a stable and consistent endpoint for accessing one or more instances of a container that run an application (or microservice) within one or more pods of cluster 102. Different cluster services correspond to different containerized applications. Multiple replicas of a container associated with a service can run within different pods within the cluster 102. The number of replicas of a pod that run a replica of a containerized application may be dynamically scaled up or down based on demand. Each cluster service has a unique IP address, and each replica of a pod that runs a container that is associated with a cluster service also has a unique IP address. The IP address of a service remains unchanged regardless of scaling up or scaling down the number of pods running containers associated with the cluster service. The kube-proxy 124₁ can use the IP addresses of services to route network traffic between containers that are members of different services. The kube-proxy 124₁ can monitor communication with the API server 105₁ to discover IP addresses of new or updated services.

Cluster 102 uses a hub-and-spoke communication architecture in which network connections can be created between API server 105₁ at control plane cluster node 104₁ and kubelet 122₁ at worker cluster node 106₁ to access cluster services such as service/IP discovery, storage, and status updates, for example. Moreover, multiple control plane cluster nodes 104₁, 104₂, and 104₃ may be required to efficiently respond to requests from kubelets at worker cluster nodes 106₁, 106₂. Load balancing between control plane cluster nodes 104₁, 104₂, and 104₃ can be used to share the burden of responding to requests.

### Dual PKI Infrastructure

Cluster 102 has two independent public key infrastructure (PKI) hierarchies: a Kubernetes PKI hierarchy and an ETCD PKI hierarchy. The Kubernetes PKI hierarchy consists of its own Kubernetes certificates (k8s-crt) and associated Kubernetes leaf certificates (k8s-leaf-crt). The Kubernetes PKI hierarchy is primarily used for securing communication between Kubernetes components such as the API server, kubelets, and controllers. The ETCD PKI hierarchy has its own ETCD certificates (etcd-ca) and ETCD leaf certificates (etcd-leaf-crt). The ETCD PKI hierarchy secures communication within etcd clusters and between etcd and Kubernetes components that interact with it. By maintaining these two independent PKI hierarchies, Kubernetes ensures that security policies can be enforced separately for both its core Kubernetes components and its data storage layer (etcd), enhancing overall security and operational integrity.

### Generating Certificates and Key Pairs for the Two PKIs

Generating k8s-ca

The Kubernetes CA (k8s-ca) 119₁ operates as the root certificate authority for Kubernetes. The k8s-ca is operable to generate a public-private key pair and a k8s-cert (e.g., an X.509 root certificate), which includes the k8s-ca's public key. The k8s-cert is operable to generate a self-signed certificate using the k8s-ca's private key and identifies the k8s-ca as a trust anchor. As explained in more detail below, a k8s-crt rotation process is used to input a k8s-cert into configuration files 123₁-123₃ and 125₁-125₂. The k8s-crt used by Kubernetes components (e.g., kubelets and control plane components) to identify the k8s-ca as a trust anchor and to verify k8s-leaf-certs.

A control cluster node can be configured to use the kubeadm utility, for example, to create a k8s-ca 119₁ during cluster bootstrap or certificate rotation by generating a k8s-ca public-private key pair and certificate. The k8s-ca private key is used to sign the generated certificate to create the k8s-crt.

Moreover, an API server 112₁ can be configured, for example, to act as k8s-ca 119₁ that can verify a Certificate Signing Request (CSR) received from a Kubernetes component, and if verified, to sign the CSR using the k8s-ca's private key to create a k8s-leaf-crt for the requesting Kubernetes component. The k8s-crt can be stored in configuration files 119₁-119₃ on control-plane nodes. Different Kubernetes components may exercise CA functionality depending on cluster configuration. For example, the kube controller manager 115₁ may be designated to perform the k8s-ca signing function. It will be understood that the k8s-crt includes the CA public key. A certificate, as used herein, refers to a machine-readable digital credential, which may include a public key, issued by Kubernetes components of the cluster to authenticate identities and establish encrypted communications over a network. The k8-crt certificate files are stored in configuration file portions 123₁-1-123₃-1 on control plane cluster nodes (e.g., /etc/kubernetes/pki/ca.crt).

Generating k8s-leaf-crt

A k8s-leaf-crt Kubernetes component, such as a kubelet 122₁, an API server 105₁, a kube controller 115₁, a scheduler 117₁, or a proxy process 124₁, can request a k8s-leaf-cert. The Kubernetes component (e.g., a kubelet) locally generates a public-private key pair and a CSR. The CSR includes the locally generated public key and identifying information that identifies the requesting Kubernetes component. The Kubernetes component uses the locally generated private key to sign the CSR. The requesting Kubernetes component uses the k8s-cert to identify the k8s-ca 119₁ (e.g., the API server 112₁ may be configured to perform the role), to which it submits the CSR. The k8s-ca 119₁ extracts the public key from the CSR and uses it to verify the CSR's signature. If approved, the k8s-ca 119₁ issues a k8s-leaf-cert (e.g., an X.509 certificate) that embeds the public key from the CSR, and that identifies the k8s-ca as being the issuer of the certificate. The k8s-ca 119₁ signs the k8s-leaf-cert using the k8s-ca's private key. Thus, the k8s-ca 119₁ uses the public key from the public-private key pair generated by the requesting Kubernetes component, which is included within the CSR, to verify the private key used to sign the CSR. Once verified, the k8s-ca 119₁ signs the k8s-leaf-cert using the k8s-ca's private key so that the k8s-leaf-crt can be used to authenticate the requesting Kubernetes component. The k8s-leaf-crt can be used in TLS handshakes to authenticate the Kubernetes component and enable encrypted communication with other Kubernetes components. The certificate files are stored in configuration files 123₁-1-123₃-1 on control plane cluster nodes (e.g., /etc/kubernetes/pki/) and in configuration files 125₁-1-125₂-1 on worker nodes (e.g., /var/lib/kubelet/pki/).

Generating etcd-crt

The etcd CA (etcd-ca) 121₁ operates as the root of trust for securing ETCD 118₁ communications. An etcd-ca is operable as a self-signed certificate authority whose private key signs etcd server, peer server, and client certificates. The etcd certificates (etcd-crts) are confined to control plane cluster nodes 104₁, 104₂, and 104₃ or dedicated etcd nodes and are not distributed to worker cluster nodes 106₁ and 106₂. A control plane cluster node can be configured using the kubeadm utility, cert manager, or openssl, for example, to be operable to generate a private key and etcd-crt (which includes a public key). The etcd private key and certificate can be used to sign leaf certificates required to initiate secure communication with the ETCD 118₁. An etcd-crt can be stored in configuration files 123₁-2-123₃-2 on control-plane nodes (e.g., /etc/kubernetes/pki/etcd/ca.crt).

Generating etcd-leaf-crt

ETCD leaf certificates (etcd-leafs) in Kubernetes are end-entity certificates signed by etcd-ca 121₁ and used by etcd servers, peers, and clients to mutually authenticate and encrypt all etcd communications, thereby isolating the etcd trust domain and enforcing secure cluster state replication and access. An etcd-leaf is trusted only within an etcd-ca trust domain. Different certificate types may be used for communication with different categories of Kubernetes components. For example, a server.crt is presented by an ETCD node when a client connects. A peer.crt is used for ETCD member-to-member communication. A client.crt is used by control plane Kubernetes components such as the Kubernetes API server to communicate with ETCD 118₁. An etcd-leaf crt can be stored in configuration files 123₁-2-123₃-2 on control-plane nodes (e.g., /etc/kubernetes/pki/etcd/).

### Initiating TLS Communication

Data in transit between components of a Kubernetes cluster is typically encrypted using Transport Layer Security (TLS). For example, when initiating a TLS session, a k8s-crt is presented to authenticate the Kubernetes components that are to participate in a TLS session and to enable encrypted communication between them. For example, at the start of a TLS handshake between a kubelet 122₁ and the Kubernetes API server 105₁, the kubelet 122₁ has its own k8s-leaf-crt and private key. Likewise, the API server 105₁ has its own k8s-leaf-crt and private key and the same k8s-crt. During the handshake, the kubelet 122₁ presents its k8s-leaf-crt to the API server 105₁, and the API server 105₁ presents its k8s-leaf-crt to the kubelet 122₁. Each side uses the k8s-ca's 119₁'s public key to verify the other peer's k8s-leaf-crt by checking the k8s-ca's signature on the other peer's k8s-leaf-crt. Each Kubernetes component performs a cryptographic operation using its private key (e.g., signing handshake data). Each peer verifies the other Kubernetes component's signature using the other Kubernetes component's public key provided in a certificate (e.g., an X.509 certificate) previously issued to the other Kubernetes component by a Kubernetes CA. The certificate conveys information such as kubelet identity, a public key, and a signature. Once identity is authenticated, both sides derive shared session keys. All subsequent communication is encrypted and integrity-protected using symmetric cryptography.

### Machine Operating as a Cluster Node Example

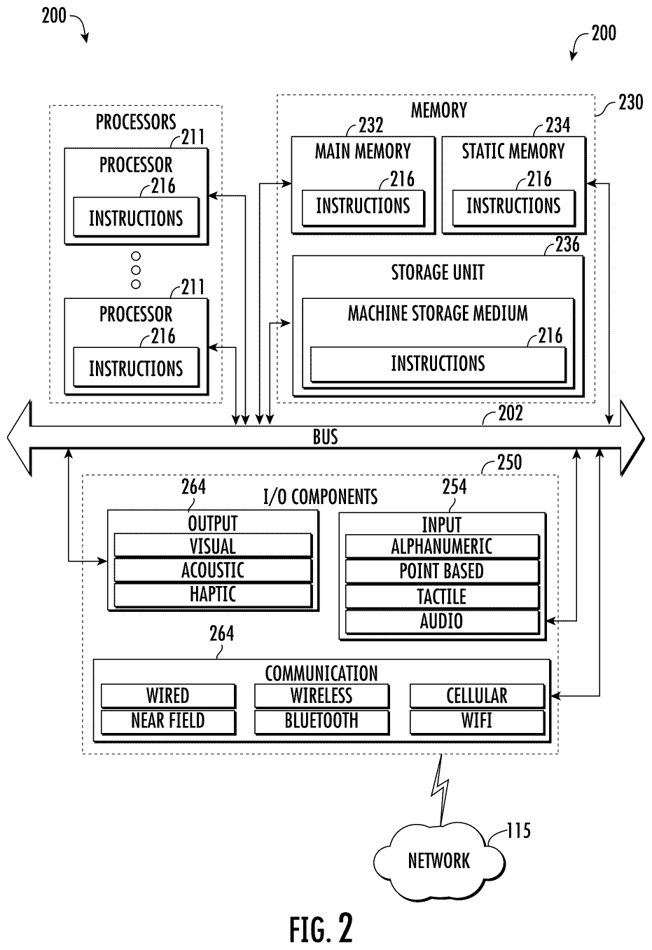

FIG. 2 is an illustrative drawing representing a computing machine 200 that can be configured to operate as a cluster node, either as a control cluster node 104₁, 104₂, or 104₃ or as a worker cluster node 106₁ or 106₂ of the cluster 102 of FIG. 1. It will be understood that although only one example machine 200 is shown, each of the nodes 104₁, 104₂, 104₃, 106₁, and 106₂ can run on a different instance of machine 200. Machine 200 comprises a computer system within which a set of instructions may be executed for causing machine 200 to perform any one or more of the methodologies discussed herein. Machine 200 can be implemented as a physical machine or as a virtual machine (VM). Instructions 216 (e.g., software, computer program code, or other executable code) may cause an example machine 200 to implement operations of the API server 105₁, scheduler 117₁, kube controller manager server 115₁, etcd store 118₁, k8s-ca 119₁, and etcd-ca 121₁ of control plane cluster node 104₁. Instructions 216 may cause a different example machine 200 to implement operations of a kubelet 122₁, a kube proxy server 124₁, and a pod 130₁, which can run one or more containers 132₁. Instructions 216 may cause an example machine 200 to implement operations of a control relay node, e.g., 208₁, 208₂, or 208₃, described below. Instructions 216 may cause an example machine 200 to implement operations of a worker relay node, e.g., 210₁ or 210₂ described below. The instructions 216 include an operating system responsible for low-level system services, including process management, memory management, device management, and system calls. The operating system 217 can respond to instructions provided by higher-level computer programs, such as service mesh clients, service mesh servers, and containerized applications. In this way, instructions 216 may transform a general, non-programmed machine 200 into a particular machine (e.g., a control plane cluster node or a worker node in a Kubernetes cluster) that is specially configured to carry out any one of the described and illustrated functions in the manner described herein.

An example machine 200 includes one or more machine-level processing components 211, machine-level memory 230, and input/output (I/O) components 250 configured to communicate with each other, such as via a bus 202. Example machine-level processing components 211 can include one or more of (e.g., a central processing unit (CPU), a reduced instruction set processing (RISC) processor, a complex instruction set processing (CISC) processor, a graphics processing unit (GPU), a digital signal processor (DSP), an application-specific integrated circuit (ASIC), or another processor, or any suitable combination thereof). Example memory 230 comprises a non-transitory computer-readable storage medium that may include a main memory 232, a static memory 234, and a storage unit 236, all accessible to one or more machine-level processing components 211, such as via bus 202, to store the executable instructions or code 216. Machine-level processing components 211 can be configured to execute code stored in machine-level memory 230, to perform operations to implement Kubernetes components described herein. Memory 230 can store configuration files 123₁-123₃ and configuration files 125₁-125₂. Example input components 254 (of the I/O components 250) may also include one or more of a keyboard, mouse, buttons, gesture input, or other input signal sensors. Example output components 252 (of the I/O components 250) may include a display screen, speakers, or other output signal generators. Example I/O components 250 may include a network interface 264 to couple the machine 200 with a network 113. Network interface components can include one or more wired, wireless, cellular, or near-field interface components. An example network interface supports communication using a network protocol, such as HTTP.

### Certificate Rotation

Certificates have a predetermined lifetime at the end of which they become expired. Certificates must be changed before expiration. The process of replacing a previous certificate with a replacement certificate is referred to herein as certificate rotation, after which certificate rotation involves changing certificates stored in configuration files.

Kubernetes Cluster with Certificate Rotation Service Mesh

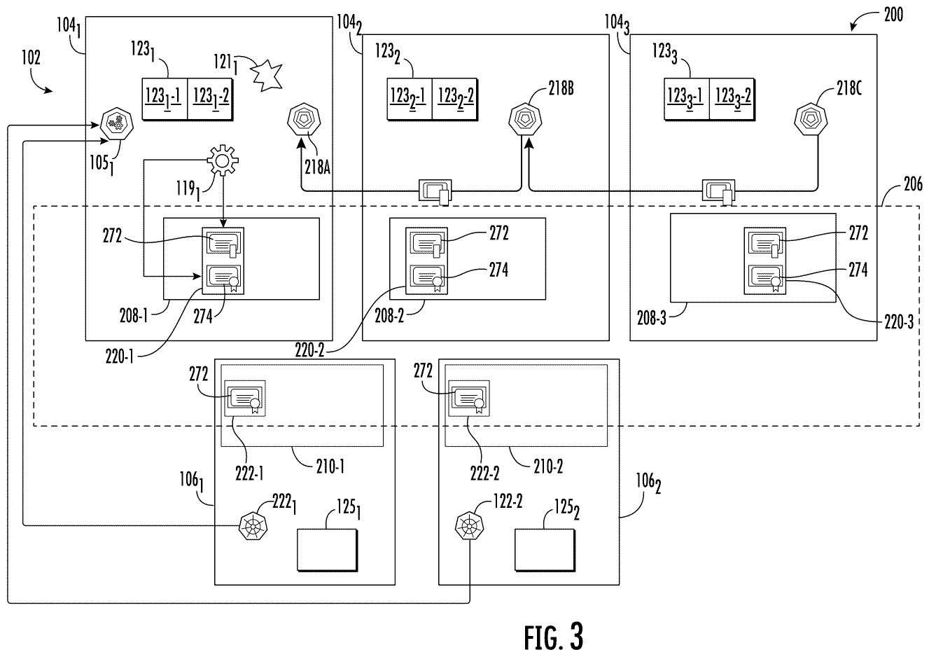

FIG. 3 is an illustrative drawing of an example distributed computing system 200 that includes the Kubernetes cluster 102 of FIG. 1 integrated with a certificate rotation service mesh network 206 (indicated by dashed lines) in accordance with some examples. For the economy of disclosure, details of system 200 that have been explained above are omitted from the drawing and will not be repeated. Kubernetes cluster 102 includes control plane cluster nodes 104₁, 104₂, and 104₃, and includes worker cluster nodes 106₁ and 106₂. The service mesh network 206 includes control relay nodes 208₁, 208₂, and 208₃ associated with respective control cluster nodes 104₁, 104₂, and 104₃, and includes respective worker relay nodes 210₁ and 210₂ associated with respective worker cluster nodes 106₁ and 106₂.

Configuration files 123₁-123₃ at control plane cluster nodes 104₁-104₃ store k8s-crts and etcd-certs used by Kubernetes components during TLS communication. Configuration files 123₁-123₃ include first portions 123₁-1-123₃-1 to store k8s-crt and k8s-leaf-crts and include second portions 123₁-2-123₃-2 to store etcd-crts and etcd-leaf-crts. The first configuration file portions 123₁-1-123₃-1 are used with the Kubernetes PKI hierarchy and the second configuration file portions 123₁-2-123₃-2 are used with the ETCD PKI hierarchy. Configuration files 125₁-125₂ at worker nodes 106₁-106₂ store k8s-leaf-crts used with the Kubernetes PKI hierarchy. The configuration files 123₁-123₃ and 125₁-125₂ are used by Kubernetes components to initiate secure TLS communication.

The k8s-crt 119₁ is operable to have previously generated a previous k8s-crt that is currently in use. The k8s-crt 119₁ is operable to generate a replacement k8s-crt while the previous k8s-crt remains currently in use, based upon a determined expiration time of the previous k8s-crt. Likewise, the etcd-crt 121₁ is operable to generate a replacement etcd-crt, while the previous etcd-crt remains currently in use, based upon a determined expiration time of the previous k8s-crt. Each control relay node 208₁, 208₂, and 208₃ includes an associated certificate data storage units 220₁-220₃, and each worker relay node 210₁ and 210₂ includes an associated certificate data storage units 222₁-222₂. The service mesh network 206 enables pre-positioning of copies of a replacement k8s-crt within data storage units 220₁-220₃ and within data storage units 222₁-222₂ while a previous k8s-crt is still stored in configuration files 123₁-123₃, and configuration files 125₁-125₂ and is still in use within the cluster 102.

The control plane cluster node 104₁ is designated as the lead control plane cluster node and the control relay node 208₁ is designated as the lead control relay node in the example distributed computing system 200 of FIG. 2. The relay nodes of the service mesh use one or more mesh protocols to determine paths between relay nodes of the service mesh network 206 on which to distribute replacement certificates to cluster nodes of the cluster 102.

The service mesh network 206 is used to distribute copies of a replacement k8s-crt among the control cluster nodes 104₁, 104₂, 104₃, 106₁, and 106₂ to replace the previous k8s-crt that is currently in use within the cluster 102. The service mesh network 206 is also used to distribute copies of a replacement etcd-crt among the control cluster nodes 104₁, 104₂, and 104₃ to replace a previous etcd-crt currently in use within the cluster 102.

The service mesh network 206 is used to pre-position or stage copies of a replacement k8s-crts and copies of a replacement etcd-crts while a previous k8s-crt is currently in use in the cluster 102 for authentication and for signing k8s-crts and while a previous etcd-crt is currently in use in the cluster 102 for authentication and for signing etcd-leaf-crts. Prepositioning k8s-crts and etcd-crts at data storage units 220₁-220₃ and 222₁-222₂ in close communication with cluster nodes 104₁-104₃ and 106₂-106₃ that will use them to minimize disruption of operation of the cluster 102 during the rotation (i.e., changing) from previous k8s-crts and etcd-crts to replacement k8s-crts and etcd-crts. For example, the service mesh network 206 can pre-position copies of a replacement k8s-crt 272 and a replacement etcd-crt 274 by distributing them to certificate data storage units 220₁-220₃ of control relay nodes 208₁-208₃ before they are inputted into control plane nodes 104₁-104₃. The service mesh network 206 can pre-position copies of a replacement k8s-crt 272 by distributing them to certificate storage units 222₁-222₂ of the worker relay nodes 210₁ and 210₂.

During a certificate rotation, due to the pre-positioning, the copies of a replacement k8s-crt and the replacement etcd-crt can be input synchronously to the cluster nodes that will use them. Synchronous input reduces disruption to the operation of the cluster 102 during certificate rotation.

One or more machine-level processing components of the control plane cluster nodes 104₁, 104₂, and 104₃ can be configured using executable computer program code to perform operations of the control relay nodes 208₁, 208₂, and 208₃. One or more machine-level processing components of the worker cluster nodes 106₁ and 106₂ can be configured using executable computer program code to perform operations of the worker relay nodes 210₁ and 210₂.

The respective service mesh network control relay nodes 208₁, 208₂, and 208₃ can run as services within pods on control plane cluster nodes 104₁, 104₂, and 104₃. The respective service mesh network worker relay nodes 210₁ and 210₂ can run as services within pods on worker cluster nodes 106₁ and 106₂. In some cases, control relay nodes 208₁, 208₂, and 208₃ can be deployed as containers within pods running on the corresponding control plane cluster nodes 104₁, 104₂, and 104₃. Similarly, worker relay nodes 210₁ and 210₂ can be deployed as containers within pods running on the respective worker cluster nodes 106₁ and 106₂. Thus, control relay nodes and worker relay nodes of the service mesh network 206 can use resources of the Kubernetes cluster 102, such as a worker cluster node's kubelet 122₁ and proxy server 124₁, to exchange information (e.g., certificates) with each other. In an alternative distributed processing system (not shown), control relay nodes can be deployed outside the Kubernetes cluster 201.

In some cases, pairs of relay nodes may use TLS for security when distributing copies of a replacement k8s-crt between them within the service mesh network 206. During such distribution, the relay nodes use the previous k8s-crt, which is to be replaced by the replacement k8s-crt during TLS handshakes while distributing the replacement k8s-crt. Copies of the replacement k8s-crt can be pre-positioned for rotation without interrupting the operation of the cluster 102. Once pre-positioned, the copies of the replacement k8s-crt can be synchronously rotated into the cluster nodes with minimal disruption to the operation of the cluster 102. The service mesh network 206 can operate as a separate network infrastructure layer in which the control and worker relay nodes have IP address ranges that differ from those of the components of the Kubernetes cluster 102.

The relay nodes employ a mesh network routing protocol to select paths through the service mesh network 206 to distribute replacement certificates (k8s-crt and/or etcd-crt) to relay nodes of the service mesh network 206. A path comprises two or more relay nodes that can communicate to relay a certificate from a relay node that has received the certificate to a relay node that has not yet received it.

An example service mesh network 206 operates with a leader-based architecture that uses a mesh protocol that comprises a combination of protocols, including a consensus protocol (e.g., for state consistency) and a gossip protocol (e.g., for membership and health checks). The mesh protocol can automatically adapt to changes in relay node membership within the service mesh, which is valuable because cluster nodes can be added and removed over the lifetime of the cluster 102.

An example consensus protocol can be used to achieve consensus among relay nodes on leadership and mesh system state to ensure strong consistency in the distributed environment of the cluster node 102. An example service mesh network 206 uses the Raft consensus algorithm (typically on port 8300).

An example gossip protocol can be configured to allow a relay node to communicate with a select number of other relay nodes and, through these interactions, transmit information to the entire service mesh network 206. When a relay node configured to use the gossip protocol receives a message, it may select a random subset of its neighboring relay nodes to forward the message to. These neighbor relay nodes then do the same, passing the message on to a selected subset of their own neighbor relay nodes, and so on, until the message has been spread throughout the service mesh network 206. An example service mesh network 206 uses the Gossip Protocol (Serf): Based on the Serf library, which can handle cluster membership, failure detection, and event broadcasting using UDP/TCP (LAN for local, WAN for cross-datacenter).

Example relay nodes can use RPC (Remote Procedure Calls) to forward requests to the leader, ensuring all state changes are processed by a single source of truth.

Example relay nodes can use HTTP/gRPC APIs for API interactions (8500-8501) and service mesh communication (8502-8503), often secured with mTLS.

Alternatively, for example, the service mesh network 206 can use a nearest neighbor routing protocol to select shortest paths on which to send replacement certificates based on determinations of which nodes are nearest neighbors to one another. Another alternative example service mesh network 206 can use a flooding routing protocol to cause replacement certificates to be transmitted over multiple paths simultaneously to maximize chances of successful arrival of the information at all relay nodes in the service mesh network 206, in case one or more nodes hosting a mesh network member fail.

### Cluster Node Operation and Service Mesh Operation Certificate Rotation

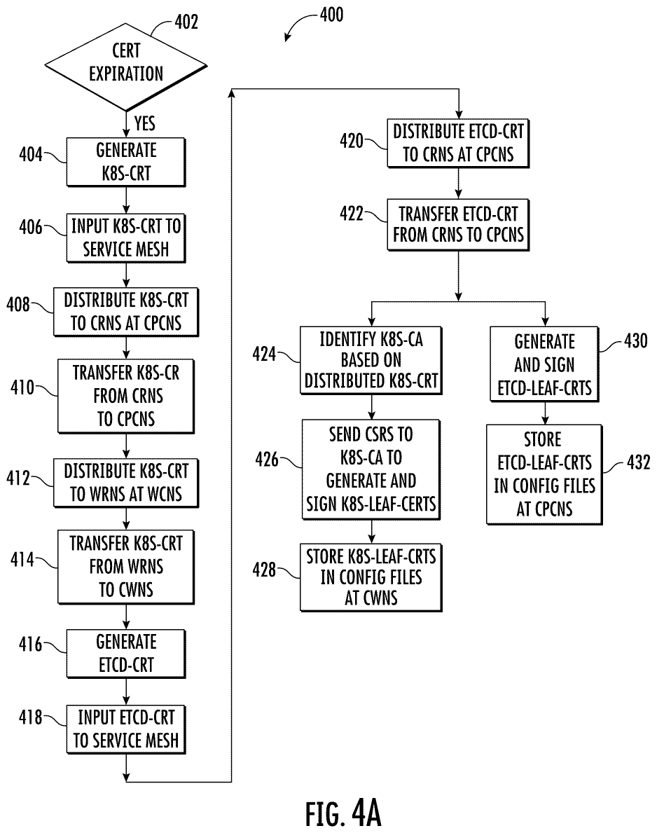

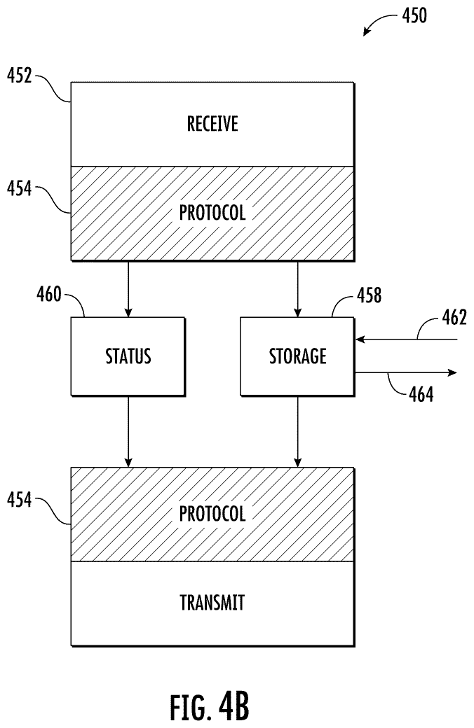

FIG. 4A is an illustrative diagram representing an example certificate rotation process 400. The example distributed computing system 200 is configured with executable instructions to implement the operations of process 400. In operation 402, a lead control plane cluster node (CCPN), e.g., 104₁, periodically checks, e.g., every 24 hours, for certificate expiration time. An example distributed computing system 200 may have numerous certificates that expire at different times. An example k8s-crt and an example etcd-crt have prescribed lifetimes, e.g., ten years each. An example k8s-leaf-cert and an example etcd-cert also have prescribed lifetimes, e.g., one year each. An example operation 402 initiates certificate rotation in response to a determination that a k8s-cert or an etcd-cert will expire within a prescribed timeframe, e.g., 30 days or less.

In operation 404, in response to a determination that a certificate is within a prescribed expiration timeframe, k8s-ca 119₁ at the lead CCPN 104₁ generates a replacement k8s-crt. In operation 406, a lead control relay node (CRN) 208₁ in the service mesh network 206 executes instructions in a script that inputs a copy of the replacement k8s-crt generated using the k8s-ca 119₁ at the lead CCPN 104₁ to a local storage unit 220₁ at the lead CRN 208₁. The replacement k8s-crt is not yet input to the configuration file 123₁ at the lead CRN 208₁. Instead, as explained below, a copy of the replacement k8s-crt is input to the configuration file 123₁ later, after copies of the cr8s-crt have been distributed to all CRNs of the service mesh network 206. In operation 408, the associated lead CRN 208₁ causes the mesh network 206 to use the mesh protocol to distribute copies of the replacement k8s-crt to the CRNs 208₂ and 208₃ at the other control plane cluster nodes (CPCNs) 104₂ and 104₃. The CRNs 208₂ and 208₃ receive copies of the replacement k8s-crt and input it to their respective local storage units 220₂-220₃. In operation 410, the CRNs 208₁-208₃ each periodically execute instructions of a script that checks receive status transfer a copy of the replacement k8s-crt from its local storage unit 220₁, 220₂, or 220₃ to a certificate file location in a configuration file 123₁, 123₂, or 123₃, to replace a previous k8s-crt.

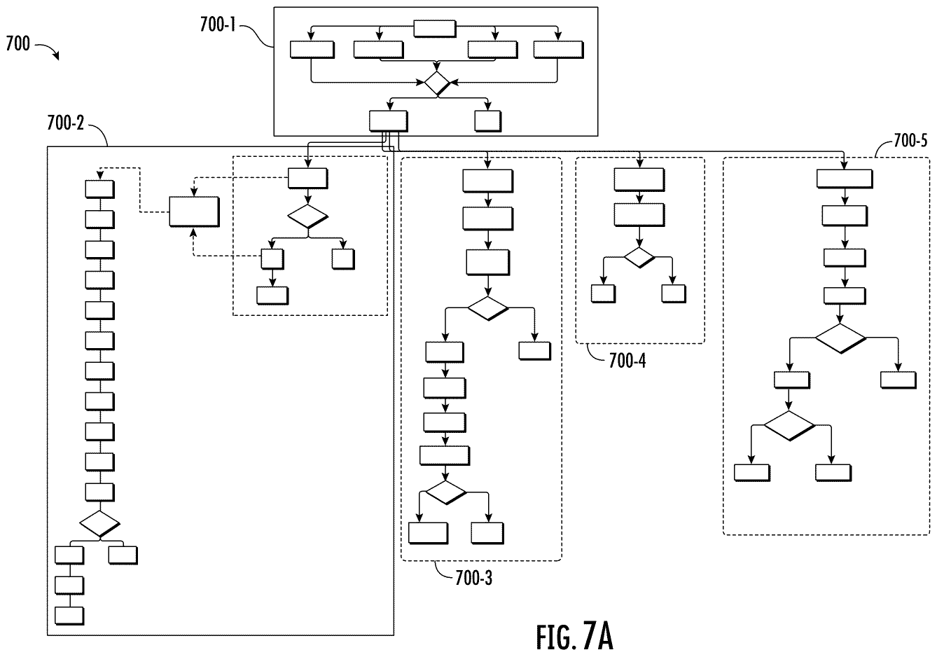

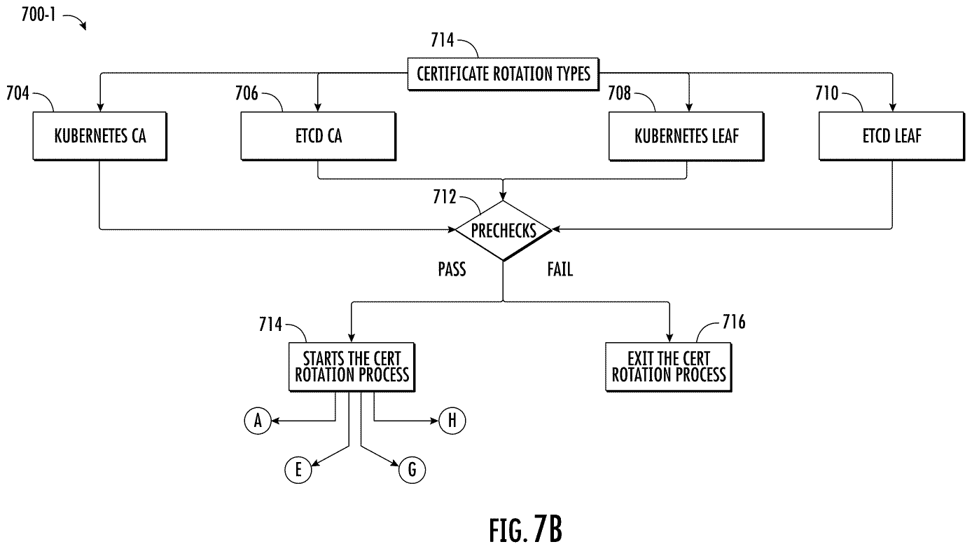

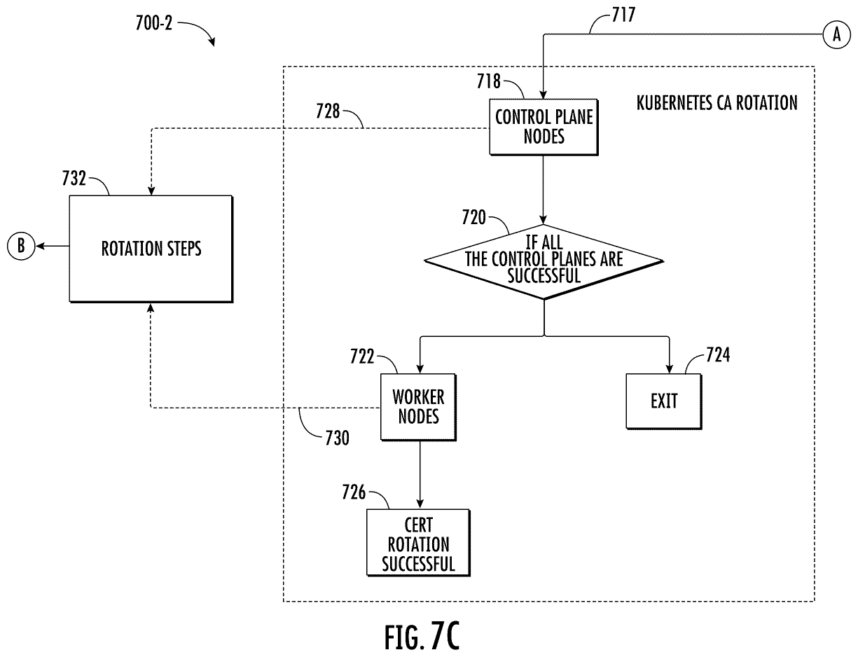

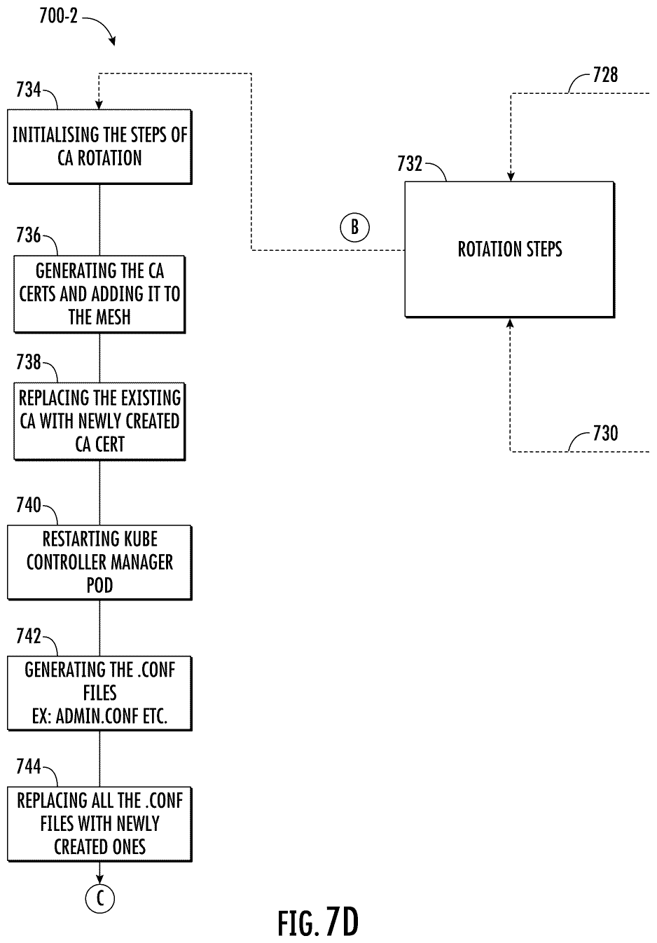

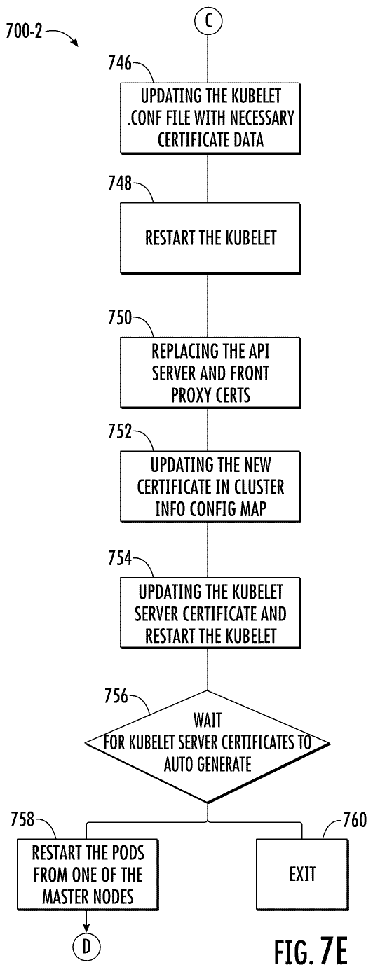

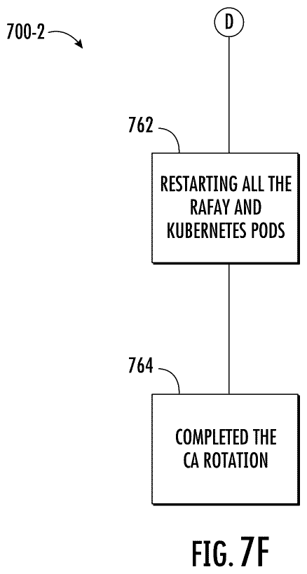

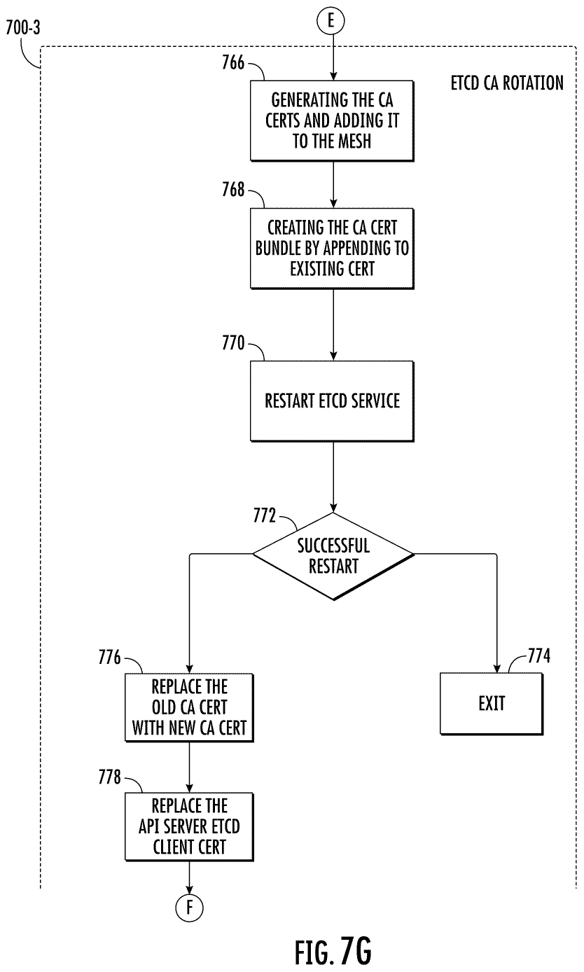

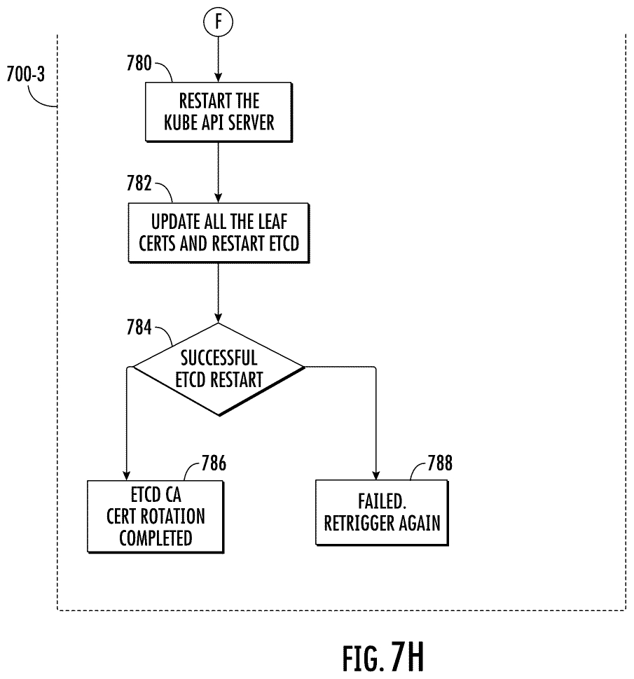

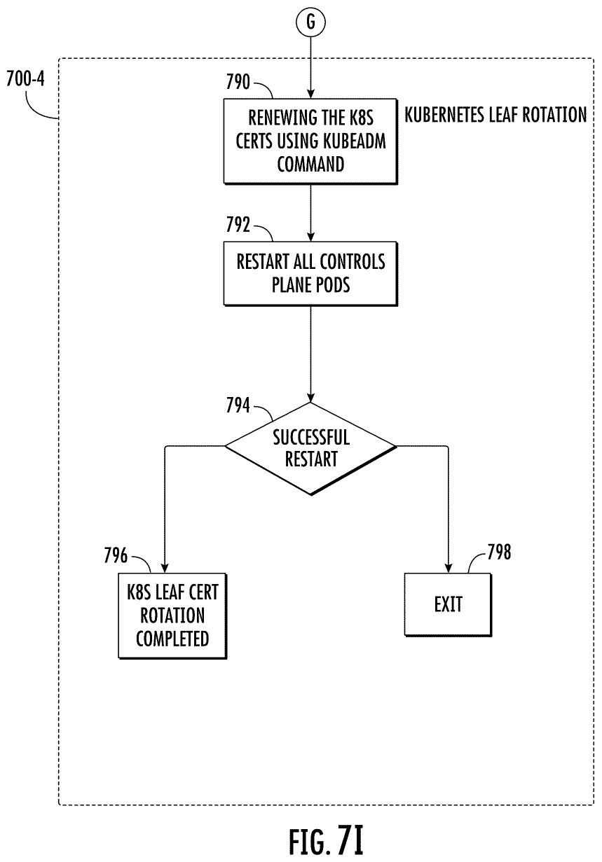

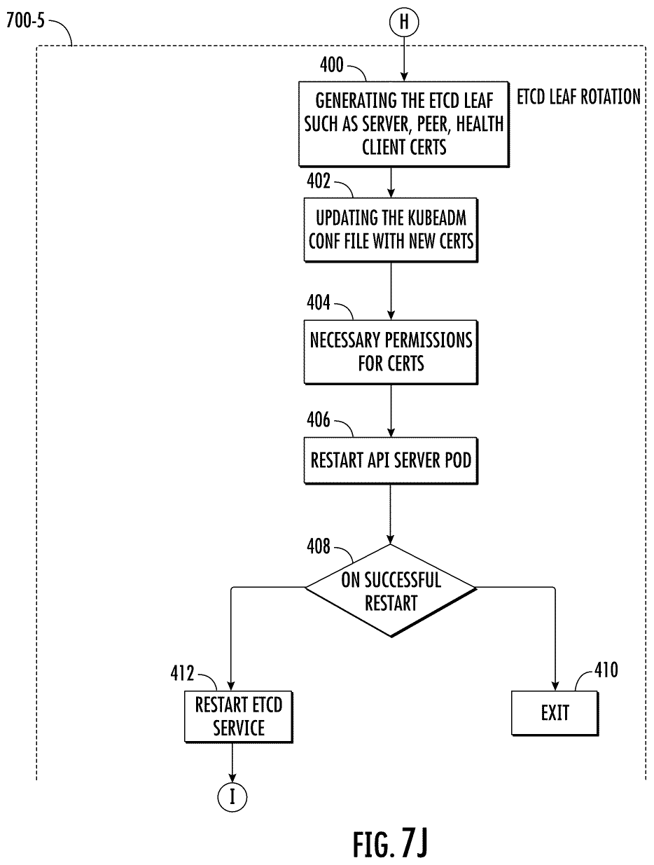

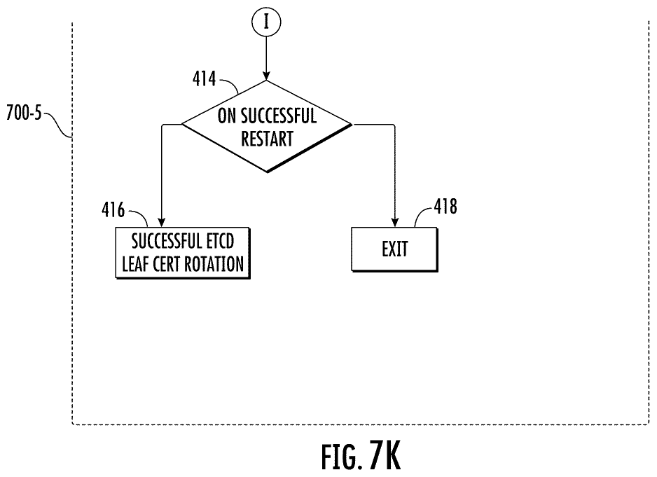

In operation 412, lead CRN 208₁ uses the mesh protocol to cause the mesh network 206 to distribute copies of the replacement k8s-crt to worker relay nodes (WRNs) 210₁ and 210₂ associated with cluster worker nodes (CWNs) 106₁ and 106₂. The WRNs 210₁-210₂ receive copies of the replacement k8s-crt and input it to their respective local storage units 222₁-222₂. In operation 414, the WRNs 210₁-210₂ each periodically execute instructions of a script that checks receive status to determine whether a replacement k8s-crt is received at a respective local storage unit 222₁-222₂ Each WRN 222₁-222₂, in response to detecting that a replacement k8s-crt certificate has been received, configures a processing component 211 to initiate a process, described with reference to FIGS. 7A-7K, to transfer a copy of the replacement k8s-crt from its local storage unit 222₁ or 222₂, at WRN 210₁ or 210₂, to a certificate file location in its configuration file 125₁ or 125₂, to replace a previous k8s-crt and to restart certain Kubernetes components of the cluster 102.

In operation 416, etcd-ca 121₁ at the lead control plane cluster node 104₁generates a replacement etcd certificate. In operation 418, the lead CRN 208₁ in the service mesh network 206 executes instructions in a script that inputs a copy of the replacement etcd-crt generated using the etcd-ca 121₁ at the lead CPCN 104₁ to local storage at the lead CRN 208₁. In operation 420, CRN 208₁ causes the mesh network 206 to use the mesh protocol to distribute copies of the replacement etcd-crt to the CRNs 208₂ and 208₃ associated with the other CPCNs 104₂ and 104₃. The CRNs 208₂ and 208₃ receive copies of the replacement etcd-crt and input it to their respective local storage units 220₂-220₃. In operation 422, CRNs 208₁-208₃ each periodically execute instructions of a script that checks receive status to determine whether a replacement etcd-crt is received at a respective storage unit 220₁-220₃. Each CRN 208₁-208₃, in response to detecting that a replacement etcd-crt certificate has been received, configures a processing component 211 to initiate a process, described with reference to FIGS. 7A-7K, to transfer a copy of the replacement etcd-crt from its local storage 220₁, 220₂, or 220₃ to file location in its configuration files 123₁, 123₂, and 123₃, replacing the previous etcd-crt and to restart certain Kubernetes components of the cluster 102.

In operation 424, CWNs 106₁, 106₂ use the replacement k8s-crt to identify the k8s-ca 119₁ at the lead CPCN 104₁. In operation 426, the respective CWNs 106₁ and 106₂ send CSRs to the k8s-ca 119₁, which responds by generating and signing respective replacement k8s-leaf-crts. In operation 428, the respective CWNs 106₁ and 106₂ receive respective signed k8s-leaf-crts from the k8s-ca 119₁ and store respective replacement k8s-leaf-crts at certificate file locations in their respective configuration files 125₁ and 125₂.

In operation 430, respective CPCNs 104₁, 104₂, and 104₃ use the replacement etcd-crt to generate respective replacement etcd-leaf-crts. In operation 432, the respective CPCNs 104₁, 104₂, and 104₃ store respective replacement etcd-leaf-crts at certificate file locations in their respective configuration file storage units 123₁, 123₂, and 123₃.

In the example certificate rotation process 400, copies of the replacement k8s-crt are distributed to the CRNs 208₁, 208₂, and 208₃ before they are distributed to the WRNs 210₁ and 210₂ to ensure that copies of the replacement k8s-crt are available on all CPCNs 104₁, 104₂, and 104₃ before Kubernetes components at the CWNs 106₁ and 106₂ attempt to use the replacement k8s-crt to establish secure communication connections (e.g., TLS) with Kubernetes components at one or more of the CPCNs 104₁, 104₂, and 104₃, for example. If not done in a sequence with k8s-crt distributed to CPCNs before being distributed to CWNs, Kubernetes components at the CWNs 106₁ and 106₂ with the replacement k8s-crt might end up trying to connect to the CPCNs with a previous (i.e., expired) k8s-crt and fail.

For similar reasons, copies of the replacement etcd-crt are distributed to the CRNs 208₁, 208₂, and 208₃ before they are distributed to the WRNs 210₁ and 210₂ to ensure that copies of the replacement etcd-crt are available on all CPCNs 104₁, 104₂, and 104₃ before the Kubernetes components at CWNs 106₁ and 106₂ attempt to use the replacement etcd-crt to establish secure communication connections (e.g., TLS) with Kubernetes components at one or more of the CPCNs 104₁, 104₂, and 104₃, for example.

The k8s-crts and k8s-leaf-crts rotation operations can run in parallel with the etcd-crts and etcd-leaf-crts rotation operations since they are independent of one another.

FIG. 4B is an illustrative functional block diagram of an example relay node 450 operative during the example process 400. Relay nodes 208₁-208₃ and 210₁-210₂ of the service mesh network 206 can be configured with executable instructions to implement the operations of the blocks of the example relay node 450. Receive block 452 is operable to use a mesh protocol 454 to receive information from other relay nodes of the service mesh network 206. Transmit block 456 is operable to use the mesh protocol 454 to transmit information over the service mesh network 206. Storage unit block 458 (e.g., any of 220₁-220₃ or 222₁-222₂) is operable to store certificates (i.e., k8s-crt and/or etcd-crt). Status block 460 is used to determine and report certificate storage status. An example input 462 is communicatively coupled to transfer certificate information (i.e., k8s-crt and/or etcd-crt) from a control plane cluster node (e.g., lead CPCN 104₁) to the storage unit 458. More specifically, an example input 462 is operable to use instructions of a script to configure a processing component 211 to cause a control plane cluster node to transfer a replacement k8s-crt to the storage unit 458. An example input 462 is also operable to use a script to configure a processing component 211 to cause a control plane cluster node to transfer a replacement etcd-crt to the storage unit 458. An example output 464 is communicatively coupled to transfer certificate information (i.e., k8s-crt and/or etcd-crt) from the storage unit 458 to a control plane node. More specifically, an example output 464 is operable to use instructions of a script to configure a processing component 211 to cause a Kubernetes component (e.g., a kubelet 122₁) on a cluster node to transfer a copy of a replacement k8s-crt from the storage unit 458 to the Kubernetes component's configuration file. An example output 464 is also operable to use a script to configure a processing component 211 to cause a Kubernetes component on a cluster node to transfer a copy of a replacement etcd-crt from the storage unit 458 to the Kubernetes component's configuration file. It will be understood that different instances of the example relay node 450 are configured to communicate with different cluster nodes, and therefore, are used to transmit and store different certificates at different times. For example, instances of the relay node 450 at CWNs do not distribute and store etcd certificates.

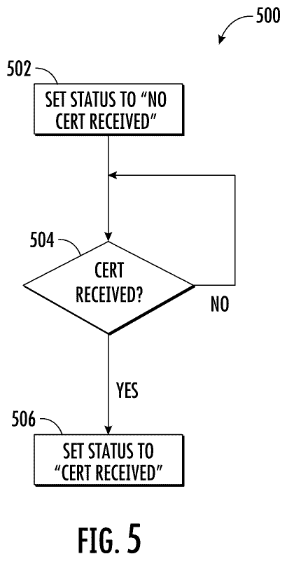

FIG. 5 is an illustrative diagram of an example relay node status-tracking process 500 performed using status block 460 of FIG. 4B during the example certificate rotation process 400 of FIG. 4A. Relay nodes 208₁-208₃ and 210₁-210₂ of the service mesh network 206 can be configured with executable instructions to perform the operations of the example process 500. In operation 502, the status of the relay nodes is set to indicate that no certificate has been received. Operation 504 determines whether a certificate has been received. In an example operation 504, CRNs 208₁-208₃ each determine whether a k8s-crt and/or an etcd-crt has been received. Also, in an example operation 504, CWNs 210₁-210₂ each determine whether a k8s-crt has been received. In operation 506, the status of a relay node changes to “certificate received” in response to receipt of a certificate at the relay node. In an example operation 506, the status of a CRN 208₁-208₃ changes to indicate a “k8s-crt certificate received” status in response to receipt of a k8s-crt and changes to indicate an “etcd-crt received status” in response to receipt of an etcd-crt. Also, in an example operation 506, the status of a WRN 210₁-210₂ changes to indicate k8s-crt certificate received status in response to receipt of a k8s-crt. (An etcd-crt is not distributed to WRNs 210₁-210₂.)

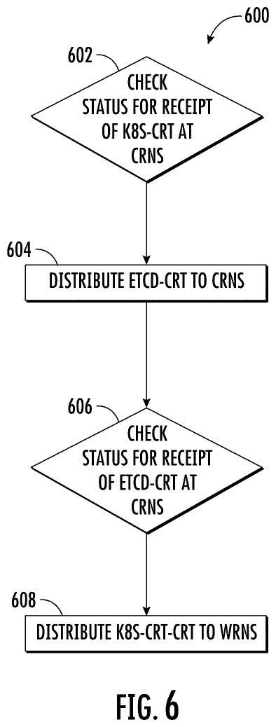

FIG. 6 is an illustrative diagram of an example relay node control process 600 to control distribution of k8s-certs and etcd-crts during the example certificate rotation process 400. A status block 406 of lead CRN 208₁ of the service mesh network 206 can be configured with executable instructions to perform the operations of the example process 600 during the example certificate rotation process 400. In this example, it is assumed that at the start of process 600, lead CRN 208₁ already is using the mesh protocol to distribute the k8s-crt to the other CRN nodes 208₂-208₃. In operation 602, the lead CRN 208₁ is operable to use the mesh network protocol to communicate with CRNs 208₂-208₃ to query whether they have received the k8s-crt. The CRNs 208₂-208₃ are operable in response to the query to use the mesh network protocol to communicate with the lead CRN 208₁ to report their status, indicating whether or not the k8s-crt has been received. In operation 604, in response to a determination that the k8s-crt has been received by all live CRNs 208₂-208₃, the lead CRN 208₁ uses the mesh network protocol to cause the distribution of the k8s-crt-crt to all live WRN nodes 210₁-210₂. In operation 606, the lead CRN 208₁ is operable to use the mesh network protocol to communicate with CRNs 208₂-208₃ to query whether they have received the etcd-crt. The CRNs 208₂-208₃ are operable in response to the query to use the mesh network protocol to communicate with the lead CRN 208₁ to report their status, indicating whether or not the etcd-crt has been received. In operation 608, in response to a determination that the etcd-crt has been received by all live CRNs 208₂-208₃, the lead CRN 208₁ uses the mesh network protocol to cause distribution of the k8s-crt to all live CRN nodes 208₂-208₃.

### Example Dual PKI Certificate Rotation Process

FIGS. 7A-7K comprise an illustrative flow diagram that represents an example dual PKI certificate rotation process 700 involving rotation of k8s-crt, k8s-leaf-crt, etcd-crt, and etcd-leaf-crt in accordance with some examples. In an example system and method, process 700 is implemented in the distributed computing system 200 using the computer program code instructions described above with reference to FIG. 2. FIG. 7A provides an overall view of the arrangement and organization of the example certificate rotation process. For ease of description, the process is divided into five stages 700-1 to 700-5. Each stage corresponds to one or more FIGS. 7B-7K as indicated in the labels on FIG. 7A. FIG. 7B is an illustrative drawing representing the first stage 700-1 of the certificate rotation process. FIGS. 7C-7F are illustrative drawings representing a second stage 700-2 of the certificate rotation process 700. FIGS. 7G-7H are illustrative drawings representing a third stage 700-3 of the certificate rotation process 700. FIG. 7I is an illustrative drawing representing a fourth stage 700-4 of the certificate rotation process 700. FIGS. 7J-7K are illustrative drawings representing a fifth stage 700-5 of the certificate rotation process 700. As explained more fully below, the second and third stages 700-2 and 700-3 can run in parallel, and the fourth and fifth stages 700-4 and 700-5 can run in parallel.
FIG. 7B is an illustrative drawing representing a first stage 700-1 of the example certificate rotation process 700 in which a precheck operation is performed. Block 702 indicates that process 700 involves rotation of four certificate types. The respective blocks 704, 706, 708, and 710 indicate that the certificate types are k8s-ca, etcd-ca, k8s-leaf-crt, and etcd-leaf-crt. A precheck operation 712 determines whether the Kubernetes cluster 102 is ready for rotation. Prechecks can include the following, for example: checking whether the kube-api server pod is running; checking whether the mesh network is running; checking whether the ETCD service is running; and checking whether the kube-api server pod is running. Operation 714 initiates certificate rotations in response to the cluster 201 passing the precheck. Operation 716 causes exit from the rotation process 700 in response to the cluster 201 failing the precheck.

FIGS. 7C-7F are illustrative drawings representing a second stage 700-2 of the example certificate rotation process 700 in which a k8s-crt rotation at control plane cluster nodes 104₁-104₃ and worker cluster nodes 106₁ and 106₂ takes place. Referring to FIG. 7C, operation 718 selects control plane cluster nodes for k8s-crt rotation. As indicated by control flow indicating line 717, operation 718 proceeds from operation 714. Each of the control plane cluster nodes 104₁-104₂, and 104₃ of example Kubernetes cluster 102 is selected to have its k8s-crt rotated using the rotation steps 732 described below. Rotations of control plane cluster nodes' k8s-crts can occur in parallel. Decision operation 720 determines whether all control plane cluster nodes have successfully completed rotation of their k8s-crts. In response to failure of all control plane cluster nodes to complete rotation of their k8s-crts, operation 724 causes exit from the process 700. In response to the successful rotation of k8s-crts by the control plane cluster nodes, operation 722 selects worker cluster nodes for k8s-crt rotation. Each worker cluster node 106₁ and 106₂ of the example cluster 102 is selected to have its k8s-crt rotated using the rotation steps 732 described below. Rotations of worker cluster nodes' k8s-crts can occur in parallel. Operation 726 signals completion of k8s-crt rotation for all control plane cluster nodes 104₁, 104₂, and 104₃ and all worker cluster nodes 106₁ and 106₂.

Referring to FIG. 7C and FIG. 7D, block 732, which is shown in both of these drawings represents operations 734-764 shown in FIGS. 7D-7F. Referring to FIG. 7D, by way overview, a designated lead control plane cluster node 104₁ performs operation 736. Control plane cluster nodes 104₁, 104₂, and 104₃ perform operations 740, 750, and 752, which apply only to control plane cluster nodes. The remaining operations are performed by both control plane cluster nodes 104₁, 104₂, and 104₃ and worker cluster nodes 106₁ and 106₂.

The first computer program code instructions that run at a leader control plane cluster node (e.g., control plane cluster node 104₁) configure one or more processors to act as a k8s-ca 119₁. Operation 734 initializes the steps for k8s-crt rotation. Operation 737 ensures that the k8s-crt and key are generated and inputted to storage in the service mesh network 206. The control plane and worker cluster nodes then retrieve the CA certificate before proceeding with operation 738, where they start using k8s-crts for authentication.

More specifically, at operation 736, the k8s-ca generates k8s-crt and key and pushes the k8s-crt and key to the mesh storage on the service mesh network 206. The k8s-ca acts as the root of trust for signing and verifying Kubernetes component certificates referred to herein as k8s-leaf-crts. In response to the input of the k8s-crt and key to the mesh storage on the service mesh network 206, the control plane cluster nodes and worker cluster nodes retrieve the k8s-crts and keys from the service mesh network 206 and store them locally in their /etc/kubernetes/pki storage.

After retrieval, each node proceeds with operation 738 to continue the certificate-based authentication process. Operation 738 replaces an existing k8s-crt at a node with a newly created k8s-crt. Each node in the cluster 102 includes a Kubernetes certificate storage, e.g., located in/etc/kubernetes/pki. Operation 738 is first performed using control cluster plane nodes 104₁, 104₂, and 104₃ and subsequently by worker cluster nodes 106₁ and 106₂. Operation 740 restarts the kube controller manager 115₁ at each control plane cluster node 104₁, 104₂, and 104₃. The restarting operation 740 ensures that the replacement k8s-crt is used by all Kubernetes components during subsequent TLS communication sessions.

Operation 742 generates configuration files. Operation 744 replaces configuration files with newly created configuration files. A variety of different configuration files can be generated. Kubelet Configuration (kubelet.conf)—Stores authentication details for the kubelet to communicate with the API server. Kubernetes API Server Configuration (kube-apiserver.conf)—Contains API server settings, including authentication and authorization details. Kubernetes API Server Configuration (kube-apiserver.conf)—Contains API server settings, including authentication and authorization details. Controller Manager Configuration (controller-manager.conf)—Holds configuration details for the Kubernetes controller manager. Scheduler Configuration (scheduler.conf)—Used for configuring the Kubernetes scheduler. Client Configuration (kubeconfig)—Often named config, used to authenticate kubectl and other clients with Kubernetes clusters.

Referring to FIG. 7E, by way of overview, operations 742, 744, 746, and 748 are first performed using control plane cluster nodes 104₁, 104₂, and 104₃ and subsequently by worker cluster nodes 106₁ and 106₂. More specifically, operation 746 updates configuration files in the kubelet.conf file. Operation 748 restarts the kubelet service. Operation 750 loads newly generated k8s-crts to replace previous k8s-crts to the API server and the front proxy server. In Kubernetes, the front-proxy is primarily responsible for handling requests between clients (like kubectl) and the API server, particularly for aggregated APIs, plays a role in authentication, authorization, and load balancing. Operation 752 updates the k8s-crt in the cluster-info config map. Operations 750 and 752 ensure that the replacement k8s-crt is used during subsequent TLS communication sessions. Operation 754 restarts the kubelet after updating new k8s-crt, which will helps to auto generate the kubelet server certificate. Operation 756 is a decision operation to wait for a server certificate to auto generate. Kubelet generates a new server certificate signed by the new CA. Auto-generation refers to the periodic regeneration of the Kubelet server certificate. If rotateCertificates: true is set, Kubelet automatically requests a new certificate. Kubelet creates a CSR and sends it to the API server for approval. In response to a failure to auto generation a server certificate, operation 770 causes the process 700 to exit. In response to successful auto generation of the server certificate, operation 758 starts rotating certificates from one of the control plane cluster nodes into the cluster's other nodes.

Referring to FIG. 7F, operation 762 restarts the Kubernetes pods. Operation 764 signals successful completion of the Kubernetes CA operation.

FIGS. 7G-7H are illustrative drawings representing a third stage 700-3 of the example certificate rotation process 700 in which an etcd-crt rotation at control plane cluster nodes takes place. Computer program code instructions that execute at a leader control plane cluster node (e.g., control plane cluster node 104₁) configures one or more processors to act as an etcd-ca. At operation 766, the etcd-ca generates etcd-crt and key and inputs them to storage on the service mesh network 206. The etcd-crt and key are required for securing communication between ETCD components and the API server. The control plane cluster nodes 104₁-104₃ retrieve the etcd-crt and store it locally in /etc/kubernetes/pki/etcd. The control plane cluster nodes then proceed with operation 768 to establish secure ETCD communication.

More particularly, operation 768 creates a k8s-crt bundle by appending to an existing certificate. A certificate bundle can include a collection of certificates used to establish trust within the cluster. A certificate bundle can include Root Certificate Authority (CA) Certificates (top-level certificates that sign other certificates in the chain, Intermediate Certificates (certificates that are signed by the root CA and can sign other certificates), and End-Entity Certificates (actual certificates used by services and clients within the cluster). Operation 770 restarts the ETCD service. Decision operation 772 awaits a successful restart of the ETCD service. In response to a failure of the ETCD service to restart, operation 774 causes the process 700 to exit. In response to a successful restart of the ETCD service, operation 776 replaces the old ETCD CA certificate with a new ETCD CA certificate on the control plane cluster nodes. Operation 778 replaces the API server ETCD CA certificates. Operation 780 restarts the kube-API server on control plane cluster nodes. It is noted that operation 780 relates to steps in FIG. 7J and FIG. 7K that pertain to leaf certificate rotation, which happens only in control plane cluster nodes. Operation 782 updates the etcd-leaf-crts and restarts the ETCD. Decision operation 784 awaits successful ETCD restart. In response to failure of ETCD restart, operation 788 causes exit from process 700 and retriggers start. In response to the successful ETCD restart, operation 786 signals completion of etcd-crt rotation. Operations 766-788 of FIGS. 7G-7H are performed using the lead control plane cluster node, e.g., control plane cluster node 104₁.

FIG. 7I is an illustrative drawing representing a fourth stage 700-4 of the example certificate rotation process 700 in which a Kubernetes leaf rotation takes place. k8s-leaf-crts can be generated locally on each node at different times based on individual renewal schedules. More particularly, when k8s-crts are rotated, then it is mandatory to rotate the corresponding k8s-leaf-crts as part of the same process. The same applies to etcd-crt rotations and etcd-leag-crts. However, if only the Kubernetes leaf rotation takes place then only the leaf certificates will be renewed in all the control plane cluster nodes. k8s-leaf-crts are not distributed via the service mesh. Instead, the k8s-leaf-crts are generated locally on each node and stored in /etc/kubernetes/pki. Since leaf certificates are specific to individual nodes and their roles, they do not need to be propagated across the cluster 102. Since k8s-leaf-crts are not distributed via the service mesh network 206, their generation timing can be managed independently per node.

Operation 790 renews k8s-leaf-crts using the kubeadm command. Operation 790 is responsible for the renewal of Kubernetes component certificates using the kubeadm tool. k8s-leaf-crts can be generated as follows. Kubernetes leaf certificates are generated using the k8s-ca, typically within the/etc/kubernetes/pki directory. The k8s-leaf-crts are generated through CSRs, which are approved and signed by k8s-ca, ensuring secure communication within cluster 102. The kubeadm tool can be used to renew the leaf certificates. The relationship between Kubernetes CA certificates and Leaf Certificates can be explained as follows. Kubernetes CA certs act as the root of trust, signing leaf certs used by various components of the cluster 201. This establishes a trusted chain, enabling secure authentication and encryption across the cluster 201. Operation 792 restarts all control plane cluster nodes. It is noted that only k8s-crt rotation type applies to both control plane and worker cluster nodes. Other certificate rotation types apply only to control plane cluster nodes, which is the reason that that only control plane pods are restarted in this example. Operation 794 awaits completion of restart of the control plane cluster nodes. In response to a failure to restart, operation 798 causes the process 700 to exit. In response to successful restart, operation 796 signals a successful Kubernetes leaf rotation.

FIGS. 7J-7K are illustrative drawings representing a fifth stage 700-5 of the example certificate rotation process 700 in which an ETCD leaf rotation takes place. ETCD leaf certificates are not distributed via the service mesh. Each node generates its own ETCD leaf certificates locally and stores them in /etc/kubernetes/pki/etcd. Kubernetes ETCD leaf certificates are created after the CA certificate is retrieved to ensure proper signing and validation. ETCD leaf certificates are generated locally on each node at different times based on individual renewal schedules. More specifically, when the ETCD CA certificates are rotated, the corresponding leaf certificates must also be rotated as part of the same process. However, if only the ETCD leaf certificates have expired (and the CA certificates are still valid), then only the leaf certificates will be rotated on the control plane cluster nodes.

Operation 800 generates etcd-leaf-crts locally on each control plane cluster node such as server, peer, health, and client certificates. etcd-leaf-crts are generated locally and etcd-crts certificates sign etcd-leaf-crts for ETCD peers and clients. The relationship between etcd-crt and etcd-leaf-crts can be explained as follows. etcd-crts validate and trust etcd-leaf-crts, enabling secure communication between ETCD nodes and clients. Operation 802 updates the kubeadm configuration file at the designated lead control plane cluster node 104₁ with the new etcd-leaf-crts. Operation 804 obtains necessary permissions, such as correct ownership and access rights. Operation 806 restarts the API serve pod. Operation 808 awaits successful restart of the API server pod. (The Kube-API server is a pod that runs in control plane cluster nodes.) In response to a failure to restart, operation 810 causes process 700 to exit. In response to successful restart, operation 812 restarts the ETCD service. Operation 814 awaits successful restart of the ETCD service. In response to a failure of ETCD to restart, operation 818 causes process 700 to exit. In response to successful ETCD restart, operation 816 signals successful etcd-leaf-crts rotation. Operations 800-818 occur on the control plane cluster nodes 104₁, 104₂, and 104₃.

The above description is presented to enable any person skilled in the art to create and run a distributed computing system with a service mesh network for rotation of Kubernetes certificates and ETCD certificates. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure might be practiced without the use of these specific details. In other instances, well-known processes are shown in block diagram form in order not to obscure the description of the invention with unnecessary detail. Identical reference numerals may be used to represent different views of the same or similar item in different drawings. Thus, the foregoing description and drawings of examples in accordance with the present invention are merely illustrative of the principles of the invention. Therefore, it will be understood that various modifications can be made to the embodiments by those skilled in the art without departing from the spirit and scope of the invention, which is defined in the appended claims.

1. A distributed computing system comprising:
a Kubernetes cluster comprising a plurality of cluster nodes; and
a mesh network comprising a plurality of relay nodes;
wherein the mesh network is operable, while one or more configuration files of the cluster nodes store a copy of a previous k8s-crt generated using a Kubernetes certificate authority (k8s-ca), to distribute copies of a replacement Kubernetes (k8s-crts) generated using the k8s-ca to the relay nodes of the mesh network;
wherein each relay node includes a storage unit configured to store a replacement copy of the k8s-crt received at the relay node;
wherein each relay node is communicatively coupled to a different cluster node;
wherein at least one cluster node includes a Kubernetes component operable as the Kubernetes certificate authority (k8s-ca);
wherein each cluster node includes a configuration file; and
wherein each cluster node is operable to receive a copy of the replacement k8s-crt from a storage unit at a relay node communicatively coupled to the cluster node, and to input the received copy of the replacement k8s-crt to a configuration file at the cluster node, to replace a copy of the previous k8s-crt stored at the configuration file.

2. The distributed computing system of claim 1,
wherein at least one relay node is communicatively coupled to receive the cluster node that includes the k8s-a to receive a copy of the replacement k8s-crt from the respective cluster node that includes the k8s-ca, and to cause the mesh network to distribute copies of the replacement k8s-crt to other relay nodes of the mesh network.

3. The distributed computing system of claim 1,
wherein each relay node is deployed as one or more containers within one or more pods running on a different cluster node.

4. The distributed computing system of claim 1,
wherein the Kubernetes cluster (cluster) includes a plurality of control plane cluster nodes and a plurality of worker cluster nodes;
wherein the mesh network is operable, while one or more configuration files of the cluster nodes store a copy of a previous k8s-crt, to distribute copies of the replacement k8s-crt to relay nodes communicatively coupled to control plane cluster nodes; and
wherein the mesh network is operable, while one or more configuration files of the cluster nodes store a copy of a previous k8s-crt and after distributing copies of the replacement k8s-crt to relay nodes communicatively coupled to control plane cluster nodes, to distribute copies of the replacement k8s-crt to relay nodes communicatively coupled to worker cluster nodes.

5. The distributed computing system of claim 1,
wherein the Kubernetes cluster (cluster) includes a plurality of control plane cluster nodes and a plurality of worker cluster nodes;
wherein at least one relay node operates as a leader relay node;
wherein other relay nodes are configured to use the mesh network to report certificate receive status to the leader node;
wherein the leader relay node is configured to cause the mesh network to distribute copies of the replacement k8s-crt to relay nodes communicatively coupled to worker cluster nodes after each of the relay nodes communicatively coupled to control plane cluster nodes has reported receipt of a copy of the replacement k8s-crt.

6. The distributed computing system of claim 4,
wherein each worker cluster node includes at least one Kubernetes component operable to use the replacement k8s-crt to send a Certificate Signing Request (CSR) to the k8s-ca after the k8s-crt is distributed to the worker node.

7. The distributed computing system of claim 1,
wherein each cluster node includes at least one Kubernetes component operable to restart in response to storing a copy of the replacement k8s-crt at a configuration file at the cluster node.

8. The distributed computing system of claim 1,
wherein each cluster node includes a kubelet operable to restart in response to storing a copy of the replacement k8s-crt at a configuration file at the cluster node.

9. The distributed computing system of claim 1,
wherein each cluster node includes one or more pods operable to restart in response to storing a copy of the replacement k8s-crt at a configuration file at the cluster node.

10. The distributed computing system of claim 1,
wherein the Kubernetes cluster includes a plurality of control plane cluster nodes and a plurality of worker cluster nodes;
wherein each control plane cluster node includes a kube controller manager operable to restart in response to storing a copy of the replacement k8s-crt at a configuration file at the control plane cluster node; and
wherein each control plane cluster node includes a kubelet operable to restart in response to storing a copy of the replacement k8s-crt at a configuration file at the control plane cluster node; and
wherein each cluster worker node includes a kubelet operable to restart in response to storing a copy of the replacement k8s-crt at a configuration file at the worker node.

11. The distributed computing system of claim 10,
wherein each control plane cluster node is operable to replace an API server in response to storing a copy of the replacement k8s-crt at a first configuration file at the control plane cluster node.

12. The distributed computing system of claim 1,
wherein the Kubernetes cluster (cluster) includes a plurality of control plane cluster nodes and a plurality of worker cluster nodes;
wherein the mesh network is operable, while one or more configuration files of the control plane cluster nodes store a copy of a previous etcd-crt generated using a Kubernetes etcd-ca (etcd-ca), to distribute copies of a replacement Kubernetes certificate (etcd-crt), generated using the etcd-ca, to the relay nodes of the mesh network;
wherein each relay node includes a storage unit configured to store a copy of the replacement etcd-crt received at the relay node;
wherein at least one cluster node includes a Kubernetes component operable as the Kubernetes ectd-ca;
wherein each control plane cluster node is operable to receive a copy of the replacement etcd-crt from a storage unit at a relay node at the control plane cluster node, and to input the received copy of the replacement etcd-crt to a configuration file at the control plane cluster node, to replace a copy of the previous etcd-crt stored at the configuration file at the control plane cluster node.

13. The distributed computing system of claim 12,
wherein the mesh network is operable, while one or more first configuration files of the cluster nodes store a copy of a previous k8s-crt, to distribute copies of the replacement k8s-crt to relay nodes communicatively coupled to control plane cluster nodes; and
wherein the mesh network is operable, while one or more first configuration files of the cluster nodes store a copy of a previous k8s-crt, after distributing copies of the replacement k8s-crt to relay nodes communicatively coupled to control plane cluster nodes, to distribute copies of the replacement k8s-crt to relay nodes communicatively coupled to worker cluster nodes.

14. The distributed computing system of claim 12,
wherein each worker cluster node includes at least one Kubernetes component operable to use the replacement k8s-crt to send a Certificate Signing Request (CSR) to the k8s-ca after the k8s-crt is distributed to the worker node.

15. The distributed computing system of claim 12,
wherein at least one relay node operates as a leader relay node;
wherein other relay nodes are configured to use the mesh network to report certificate receive status to the leader node;
wherein the leader relay node is configured to cause the mesh network to distribute copies of the replacement k8s-crt to relay nodes communicatively coupled to worker cluster nodes after each of the relay nodes communicatively coupled to control plane cluster nodes has reported receipt of a copy of the replacement k8s-crt.

16. The distributed computing system of claim 12,
wherein each cluster control plane node includes at least one Kubernetes component operable to restart in response to storing a copy of the replacement k8s-crt at a configuration file at the Kubernetes component.

17. The distributed computing system of claim 12,
wherein each control plane cluster node includes a kube controller manager operable to restart in response to storing a copy of the replacement k8s-crt at a configuration file at the control plane cluster node; and
wherein each control plane cluster node includes a kubelet operable to restart in response to storing a copy of the replacement k8s-crt at a configuration file at the control plane cluster node;
wherein each control plane cluster node includes an API server operable to restart in response to storing a copy of the replacement etcd-crt at a configuration file at the control plane cluster node; and
wherein each cluster worker node includes a kubelet operable to restart in response to storing a copy of the replacement k8s-crt at a configuration file at the worker node.

18. The distributed computing system of claim 12,
wherein each control plane cluster node includes a kube controller manager operable to restart in response to storing a copy of the replacement k8s-crt at a configuration file at the control plane cluster node; and
wherein each control plane cluster node includes a kubelet operable to restart in response to storing a copy of the replacement k8s-crt at a configuration file at the control plane cluster node;
wherein each control plane cluster node includes an ETCD service operable to restart in response to storing a copy of the replacement etcd-crt at a configuration file at the control plane cluster node; and
wherein each cluster worker node includes a kubelet operable to restart in response to storing a copy of the replacement k8s-crt at a configuration file at the worker node.

19. The distributed computing system of claim 18,
wherein each control plane cluster node is operable to replace an API server in response to storing a copy of the replacement k8s-crt at a configuration file at the control plane cluster node.

20. The distributed computing system of claim 12,
wherein the mesh network is operable to use at least one mesh protocol to distribute copies of the replacement k8s-crt within the mesh network.

21. The distributed computing system of claim 12,
wherein the mesh network is operable to use at least one mesh protocol to distribute copies of the replacement k8s-crt within the mesh network; and
wherein the mesh network is operable to use the at least one mesh protocol to distribute copies of the replacement etcd-crt within the mesh network.

22. A method of rotating a Kubernets certificate within a Kubernetes comprising:
using a Kubernetes certificate authority (k8s-ca) to generate a replacement Kubernetes certificate (k8s-crt);
using a mesh network comprising a plurality of relay nodes to distribute copies of the replacement k8s-crt to relay nodes of the mesh network, while one or more configuration files of the cluster nodes store a copy of a previous k8s-crt;
storing copies of the replacement k8s-crt in storage units at the relay nodes; and
transferring copies of the replacement k8s-crt from different ones of the relay nodes' storage units to the different ones of the cluster nodes' configuration files to replace the previous k8s-crt in the configuration files.

23. The method of claim 22 further including:
deploying the relay nodes as one or more containers within one or more pods running on different cluster nodes.

24. The method of claim 22 further including:
using a mesh network to distribute copies of the replacement k8s-crt to relay nodes communicatively coupled to control plane cluster nodes, while one or more configuration files of the cluster nodes store a copy of a previous k8s-crt; and
distributing copies of the replacement k8s-crt to relay nodes communicatively coupled to worker cluster nodes, after distributing copies of the replacement k8s-crt to relay nodes communicatively coupled to control plane cluster nodes, and while one or more configuration files of the cluster nodes store a copy of a previous k8s-crt.

25. The method of claim 24 further including:
using at least one Kubernetes component to use the replacement k8s-crt to send a CSR to the k8s-ca after the k8s-crt is distributed to the worker node.

26. The method of claim 22 further including:
designating at least one relay node as a leader relay node;
using other relay nodes to report certificate receive status to leader node;
using the leader node to cause the mesh network to distribute copies of the replacement k8s-crt to relay nodes communicatively coupled to worker cluster nodes after each of the relay nodes communicatively coupled to control plane cluster nodes have reported receipt of copies of the replacement k8s-crt.

27. The method of claim 22 further including:
using an etcd certificate authority (etcd-ca) to generate a replacement etcd certificate (etcd-crt);
distributing copies of the replacement etcd-crt to relay nodes communicatively coupled to control plane cluster nodes, while one or more configuration files of the control plane cluster nodes store a copy of a previous etcd-crt; and
storing copies of the replacement etcd-crt in storage units at the relay nodes; and
transferring copies of the replacement etcd-crt from different ones of the relay nodes' storage units to different ones of the cluster nodes' configuration files to replace the previous etcd-crt in the configuration files.

28. The method of claim 22 further including:
using a mesh network to distribute copies of the replacement k8s-crt to relay nodes communicatively coupled to control plane cluster nodes, while one or more configuration files of the cluster nodes store a copy of a previous k8s-crt;
distributing copies of the replacement k8s-crt to relay nodes communicatively coupled to worker cluster nodes, after distributing copies of the replacement k8s-crt to relay nodes communicatively coupled to control plane cluster nodes, and while one or more configuration files of the cluster nodes store a copy of a previous k8s-crt; and
using at least one Kubernetes component to use the replacement k8s-crt to send a CSR to the k8s-ca after the k8s-crt is distributed to the worker node.

29. The method of claim 22 further including:
using a Kubernetes certificate authority (k8s-ca) configured in at least one of the cluster nodes to generate the replacement k8s-crt.

30. A non-transitory computer-readable storage medium including a set of instructions that, when executed by one or more computer processors, causes the one or more computer processors to perform operations comprising:
using a Kubernetes certificate authority (k8s-ca) to generate a replacement Kubernetes certificate (k8s-crt);
using a mesh network comprising a plurality of relay nodes to distribute copies of the replacement k8s-crt relay nodes of the mesh network, while one or more configuration files of the cluster nodes store a copy of a previous k8s-crt;
storing copies of the replacement k8s-crt in storage units at the relay nodes; and
transferring copies of the replacement k8s-crt from different ones of the relay nodes' storage units to different ones of the cluster nodes' configuration files to replace the previous k8s-crt in the configuration files.
